(19) United States
(12) Patent Application Publication
(10) Pub. No.: US 2009/0101546 A1
(43) Pub. Date: Apr. 23, 2009

(54) Distillation tower construction and operation

(75) Inventors: Theodore Sideropoulos, New York, NY (US); Andrew P. Sullivan, Ashburn, VA (US); Arun K. Sharma, Missouri City, TX (US); Berne K. Stober, Chonburi (TH); Vikram Singh, Naperville, IL (US); Brian A. Albert, Fairfax, VA (US)

Correspondence Address: ExxonMobil Research & Engineering Company, P.O. Box 900, 1545 Route 22 East, Annandale, NJ, 08801-0900, US

(73) Assignee: ExxonMobil Research and Engineering Company, Annandale, NJ (US)

(21) Appl. No.: 12/285,155

(22) Filed: Sep. 30, 2008

Related U.S. Application Data
(60) Provisional application No. 60/960,939, filed on Oct. 22, 2007.

(51) Int. Cl. B01D 3/10; B01D 3/14; B01D 3/32; C10G 7/06

(52) U.S. Cl. 208/366; 202/158; 203/40

(57) ABSTRACT

A combination of differently sized structured packings in the wash zone of distillation towers is provides advantages at high vapor rates. The use of a large crimp structured packing below a smaller crimp size structured packing is advantageous for vacuum crude unit service where fouling resistance is desirable and liquid entrainment into the wash zone is a problem at high vapor rates. The tower may be operated at high vapor flux rates or C 0.4 ft/sec or higher (0.12 m/sec). An unexpected characteristic of the combinations is that the entrainment increases only slowly with increasing vapor flux rate up to Cs values of at least 0.55 ft/sec (0.17 m.sec), as compared to other packings such as random packing, grid packing and combinations of grid packing with structured packing which allow entrainment to increase sharply at high vapor rates.

### CROSS REFERENCE TO RELATED APPLICATIONS

This application relates to and claims priority to U.S. Provisional Patent Application No. 60/960,939, entitled “Distillation Tower Construction and Operation,” filed on Oct. 22, 2007.

### FIELD OF THE INVENTION

This invention relates improvements in distillation tower construction and operation. It is particularly applicable to vacuum distillation towers used for the fractionation of petroleum crudes but it may also be used in towers and units of other types where entrainment of a component separated from the incoming feed liquid presents problems, typically in atmospheric towers and fractionators in other applications.

### BACKGROUND OF THE INVENTION

Separation units, such as atmospheric distillation units, vacuum distillation units and product strippers, are major processing units in a petroleum refinery or petrochemical plant. Atmospheric and vacuum distillation units are used to separate crude oil into fractions according to boiling point for downstream processing units which require feedstocks that meet particular specifications. In the initial fractionation of crude oil, higher efficiencies and lower costs are achieved if the crude oil separation is accomplished in two steps following any initial treatment such as desalting: first, the total crude oil is fractionated at essentially atmospheric pressure, and second, a bottoms stream of high boiling hydrocarbons (the atmospheric resid) is fed from the atmospheric distillation unit to a second distillation unit operating at a pressure below atmospheric, referred to as a vacuum distillation tower. The reduced pressure in the vacuum tower allows the unit to separate the bottoms fraction from the atmospheric tower into fractions at lower temperature to avoid thermally-induced cracking of the feed. A variety of schemes are possible for integrating the crude distillation units, for example, two vacuum towers following the atmospheric tower.

Vacuum tower construction and operation has become rather specialized by reason of the operating requirements which include the need to handle very large volumes of vapor and the fact that the resid feed, being a high boiling hydrocarbon, is apt to undergo thermal degradation and form adherent, high molecular weight residues normally known as “coke”, on processing equipment. As a result of these trying operating requirements, the design of the vacuum tower has taken on its own characteristics not generally shared by other units. Generally, the tower comprises a flash zone located below the feed inlet and a wash section directly above the inlet; additionally, a stripping section may be located below the flash zone. The feed is introduced into the tower through tangential feed horns or other inlet devices which have the purpose of minimizing entrainment of liquid droplets by the ascending vapor stream: droplet formation is not desired but cannot be avoided because of the high velocities and shear forces which prevail in the flash zone. The unvaporized liquid components pass downwards in the lower section of the tower where contact with hot vapors including stripping steam strips out the more volatile components of the feed by reducing the partial pressure of the hydrocarbons and allows them to rise into the upper part of the tower.

Entrainment of the heavy, liquid portion of the feed into the upper part of the vacuum tower is a particular problem. This is particularly the case within many commercial designs of vacuum towers in which the two phase feed stream enters the tower under turbulent conditions so that the separated resid droplets are easily entrained in the ascending vapors. Flash zone flow patterns may also contribute to entrainment in the flash zone. Entrainment is undesirable because first, the high boiling or undistillable fractions may be undesirable in the vacuum gas oil because the entrained heavier hydrocarbons typically contain metals such as nickel or vanadium which are part of the hydrocarbon molecular structure that can poison the catalysts used in downstream processing and second, because of their physical properties, e.g. viscosity and wax content (in lube units). While some metal components enter the lighter fractions by vaporization of hydrocarbon molecules that include metal-containing compounds in their molecular structure, reduction of entrainment is a more effective method of reducing metals contamination as it is the heavier fractions in which these contaminants are concentrated. For this reason, the present invention may be applied to fractionation or distillation towers for which liquid flow rates are low (less than approximately 80 l.min⁻¹ m⁻² (2 gpm/ft²)) regardless of the operating pressure if the construction of the towers or their operating regimes have led to entrainment problems.

Vacuum tower operation is also plagued by coking in the wash section of the tower into which the ascending vapors from the flash zone pass, normally by way of a liquid collector tray (chimney tray). The wash zone typically consists of a liquid collector tray, a packed bed which may contain one or more types of packing, and a wash oil distributor, typically a spray bar or a trough. The wash oil, typically heavy gas oil, is used to wash down any entrainment collected on the surface of the wash zone packing. Typical wash zone packings are grids, random packings, structured packings, and combinations of grids and random or structured packings. Early designs used random or “dump” packings such as Raschig rings or Nutter rings but these have generally been replaced by ordered packing such as mesh packing, structured packing or grid packing. Until now, it was believed that there was no clear evidence on the superior capacity of-structured packing for wash zone service The move to deep cut distillation to recover as much useful liquid product from the crude as possible has, however, exacerbated the coking problem since the heavier fractions sent into the wash zone by the use of higher flash zone temperatures are more prone to thermal degradation with the result that coke deposits on the wash zone packings are more prevalent. Add to this, the need in a highly competitive economic environment to improve refinery margins has created a trend to higher vapor rates and these have led to increased entrainment of heavy ends into the gas oil liquid product. The increased coking resulting from the entrainment of the heavy ends, diminishes the area available for vapor movement and this, in turn, increases the velocity of the ascending vapors in the remaining area; the increased velocity increases the droplet entrainment and so, the tower problems become cumulative in their effect.

### SUMMARY OF THE INVENTION

We have now found that a combination of different types of structured packings in the wash zone of the vacuum tower is effective to reduce entrainment, especially at high vapor rates. The use of a large crimp structured packing below a smaller crimp structured packing effectively reduces entrainment of heavy ends into the upper portion of the tower and is therefore advantageous for service in the wash zone of the vacuum crude unit where fouling resistance is most desirable. This combination of packing types, unlike other combinations, is particularly notable for its ability to reduce entrainment at high vapor rates. The packing combination may, however, be used in services other than crude oil vacuum towers where reduction of entrainment is desirable.

According to the present invention there is therefore provided a distillation tower useful for service in environments where fouling is encountered, which comprises a feed inlet zone and a wash zone above the feed inlet zone which has two types of structured packing arranged one above the other, the lower structured packing having a larger crimp size and a lower specific surface area than the upper structured packing.

In service, the tower may be operated at high vapor flux rates or high “C Factors”. Cs is widely recognized as the measure of the vapor load in a tower of a given diameter. “Cs” is defined by the equation:

Cs=Q/A*[ρ_{V}/(ρ_{L}−ρ_{V})]^{0.5}

where

Q=Volumetric flow rate, ft³/sec (m³/sec)

A=Cross sectional area for flow, ft² (m²)

ρ_{L}=Density of liquid, lb/ft³ (kg.m²)

ρ_{V}=Density of liquid, lb/ft³(kg.m²)

and thus represents the velocity of the vapor through the cross sectional area of the tower (vapor actual cubic feet/meters per second of vapor per square foot/square meter of tower cross sectional area) multiplied by the square root of the vapor density and divided by the square root of the difference of the densities of liquid minus vapor. In this equation, the subscript “s” stands for superficial and is appropriate for packed towers since the entire cross sectional area is occupied by packing. The present packing combinations are especially useful at Cs of 0.4 ft/sec or higher, especially 0.45 ft/sec or higher, e.g. 0.48 ft/sec or even above 0.50 ft/sec (corresponding SI Cs Factors are 0.122, 0.137, 0.146 and 0.1524 m/sec). An unexpected characteristic of the present combinations is that the entrainment increases only slowly with increasing vapor flux rate up to a Cs value of at least 0.55 ft/sec, as compared to other packings and combinations of packings which allow entrainment to increase sharply at high vapor rates where entrainment dominates. Thus, structured packing combination is particularly useful in the packed wash zone sections of vacuum towers where low liquid rates and high vapor rates prevail.

In its particular application to vacuum distillation of atmospheric (“long”) resids, the method of separating the hydrocarbon components of different boiling ranges from the atmospheric resid feed comprises distilling the residual feed stream in the vacuum tower comprising a feed inlet zone with a wash zone located above the feed inlet zone and which comprises (i) a lower packing zone of structured packing and (ii) an upper packing zone of structured packing superimposed over the lower packing zone, the lower structured packing having a larger crimp size than the upper structured packing; the distillation is carried out under reduced pressure at a Cs value in the wash zone of at least 0.4 ft/sec (0.122 m/sec). In operation of the tower, a wash liquid is distributed onto the top of the wash zone packing and is allowed to pass downwards over the packing to carry entrained liquid back to the lower portion of the tower below the wash zone. The resid fraction which passes downwards from the flash zone may be stripped in a stripping zone by means of stripping steam admitted to this zone at the bottom of the tower.

### DRAWINGS

FIG. 1 of the accompanying drawings is a graph relating the entrainment at different Cs for a number of different vacuum tower wash zone packings.

### DETAILED DESCRIPTION

The present invention makes use of a combination of structured packings in a distillation tower or other tower in which liquid and vapor phases are to be brought into contact with one another. The invention is particularly applicable to service in vacuum towers used for the distillation of atmospheric resids produced by the initial atmospheric pressure distillation of crude oils but it may also be applied in other services where entrainment of liquids by vapors is a problem and for which liquid flow rates are low (less than approximately 80 l.min⁻¹ m⁻² (2 gpm/ft2)). As shown by the comparative testing described below, the combination of structured packings is functional with hydrocarbons such as solvent oil and from this it follows that comparable advantages may be expected in applications other than vacuum towers where entrainment is a problem.

Structured packing has found increased use in process applications due to its efficiency and low pressure drop characteristics. Structured packings are tower packing materials which comprises crimped (corrugated) metal plates arranged to allow movement of descending liquid in a continuous and convoluted path over the plates and through the packing. The plates in the packing are typically arranged so that the corrugations of adjacent plates are at an angle to the adjacent plate with the adjacent plates contacting each other at regularly spaced intervals to permit the liquid to flow directly from one plate to the next at the points where the angled corrugations of the plates contact one another. The continuity of surface is important to the functioning of the packing since free-falling liquid droplets are liable to be entrained by the upward-moving vapor, the more so as vapor flux increases. Structured packings may, however, have relatively small sized tabs or holes punched out from the surfaces to enhance mass transfer. Structured packings can therefore be distinguished from grid packings which have metal strip elements stacked in successive layers with extensive orphan surfaces, that is, surfaces leading to edges from which the liquid has to fall into the ascending vapor stream. The strips in the grid may have vertical elements or portions as in a conventional grid, additionally with elements or portions at some angle relative to the vertical, again with the significant extent of orphan surfaces. Structured packing can be obtained from commercial suppliers with various packing densities, angular relationships between the corrugations, and performance characteristics. Grid packings have been conventionally viewed as being superior for service in environments subject to fouling, erosion and coking but their deficiency is that entrainment tends to increase disproportionately at high rates of vapor flux as liquid droplets falling from the orphan surfaces are picked up by the fast moving vapor stream.

Structured packing is used in the vacuum tower in conjunction with a liquid distributor placed above the packing to distribute a limited amount of wash liquid, usually HVGO product of the tower, to the packing. The liquid phase comprising wash liquid descends within the structured packing as a film on the surfaces of the crimped plates. At the same time, the vapor phase ascends the column through the vapor passages within the packing provided by the corrugations so as to cause intimate contact at the interfaces between the liquid and vapor phases.

According to the present invention, the packed zone in the tower utilizes at least two structured packings of different crimp sizes arranged atop one another. The lower or lowest layer of packing is a large crimp size packing and successively higher layers have successively smaller crimp sizes. Normally, two layers of different sizes is sufficient for good mass transfer without excessive entrainment at higher vapor rates so that the system can be described as having a relatively large crimp structured packing underneath a small crimp packing.

The crimp size of a structured packing is the distance between the opposite peaks of the crimps or corrugations. This can be conveniently assimilated to the side-to-side dimension of a single plate of the packing. Packings normally considered to be large crimp packings have a crimp size of at least 30 mm, e.g. 30-70 mm, and in most cases, the crimp size will be in the range of 30-50 mm with sizes from 30-40 mm being typical; larger crimp sizes are, however, not to be excluded. Packings normally considered to be small crimp size packings will conversely have crimp sizes less than 30 mm, typically in the range of 5-30 mm, e.g. 10-25 mm, for vacuum tower service. The actual crimp size is not, however, as significant to the operation of the packing combination since actual service requirements will vary, e.g. in terms of vapor and liquid rates with the actual selection made on an empirical basis. The key factor is that a larger size crimp packing should be used below a packing with a relatively smaller crimp size (relative to the packing below it in the succession). Thus, typically, a large crimp packing with a crimp size of 30-50 mm will form the lower layer of packing with a superimposed layer of packing with a crimp size of 5-30 mm. Optimal combinations of packing materials will have a significant difference in crimp sizes so that a lower layer with a crimp size of 40-50 mm may be preferred under a packing with a smaller crimp size in the range of 10-30 mm. If desired, three or more layers of packing may be employed with two or more crimp sizes, the crimp size decreasing from bottom to top of the packing layers.

Bed height is also a significant factor in commercial operation since the recollection efficiency increases with bed height since liquid entrained by the vapor stream will tend to be recaptured higher up in the bed. Normally, total bed height will be in the range of 1 to 3 m (about 40 inches to 9.8 ft) with heights of at least about 1.1 m (about 43 inches) normally suitable for vacuum tower use; bed heights of at least 1.3 m (51 inches) are typically preferred and approximately 1.5 m (59 inches) being optimal or close to optimal. The ratio between the heights of the layers of large and small packings will be determined in part by the layer thicknesses available from the manufacturer(s) but generally, will be in the range of 30:70 to 70:30 with an approximate median of 50:50 commonly representing a workable value.

Another factor in the choice of structured packing material is that smooth surfaced structured packing are preferred. While packings with dimples, tabs or holes in the sheets are not excluded, their use is normally considered less than optimal since they may actually increase entrainment, particularly at high vapor rates, as a consequence of the orphan surfaces which permit liquid droplets to fall off into the ascending vapor stream.

Confirmation of the improvement in vacuum tower operation was afforded by comparative testing of a number of different packings and packing combinations in cold flow testing. The testing was carried out in a tower with a diameter of 4 ft (1.22 m) at a temperature of 32-43° C.) using air as the vapor; a light hydrocarbon solvent oil (Isopar™ M) was injected as spray with the air feed to emulate wash oil. The liquid rate was held at 0.1-0.3 gpm/ft² (4.1-12.2 l/min/m²) while air rate was varied to obtain different values of Cs for the system. The solvent oil carried up and out of the packing was collected and measured to provide an indication of the effectiveness of the packings in holding down entrainment.

The testing was carried out on the packings designated below; where a combination of packings was used, the smaller structured packing was used as the upper bed.

| Packing | Bed Height, in (cm) |
|---|---|
| Random Packing | 36 (91) |
| Grid 1 | 36 (91) |
| Struct. Packing B (Large Crimp) | 35 (89) |
| Grid 1 + Struct. Packing A (Small Crimp) | 17 + 17 (43 + 43) |
| Struct. Packing B (Lge.) + Struct. Packing A | B: 15 + A: 17 (38 + 43) |
| (Small) | |
| Struct. Packing B (Lge.) + Struct. Packing A | B: 25 + A: 33 (63 + 84) |
| (Small) | |

| | | |
|---|---|---|
| Notes: | | |
| Random Packing: | Rings, 50 mm | |
| | Specific Surface Area: | 29 ft²/ft³ (95 m².m⁻³.) |
| Grid Packing 1: | 7 cm grid size | |
| | Specific Surface Area: | 14.4 ft²/ft³ (47 m².m⁻³.) |
| Struct Packing A: | Crimp Size: 25 mm | |
| | Specific Surface Area, | 38 ft²/ft³ 125 m².m⁻³. |
| Struct Packing B: | Crimp Size: 45 mm. | |
| | Specific Surface Area: | 19.5 ft²/ft³ (64 m².m⁻³) |

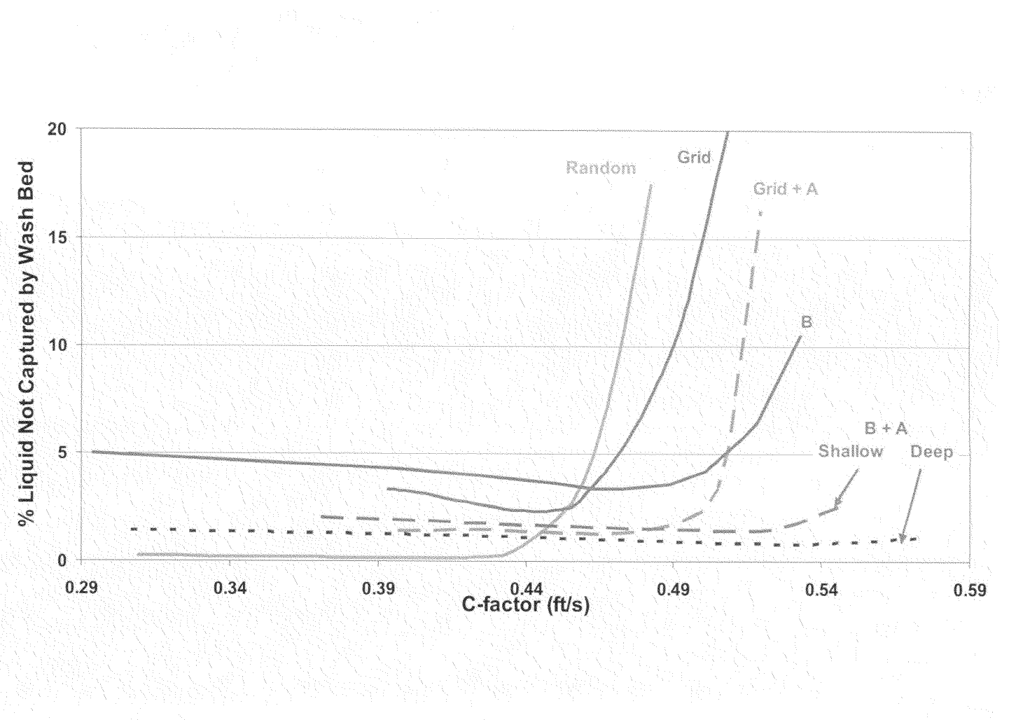

The results of the testing are shown below in Table 1 which reports the value of Cs at the onset of significant entrainment and graphically in FIG. 1 which plots the entrainment of oil by the air stream at different Cs Factors.

| | | | Cs at Onset of |
|---|---|---|---|
| | Liquid Rate, | Cs Range, | Entrainment, |
| | gpm/ft | ft/sec | ft/sec |
| | (l/min/m² | (m/sec) | (m/sec) |
| Random Packing | 0.2 | 0.31-0.48 | 0.44 |
| | | (0.09-0.15) | (0.13) |
| Grid 1 | 0.2-0.3 | 0.39-0.51 | 0.46 |
| | (8.14-12.22) | (0.12-0.15) | (0.14) |
| Struct. Packing B | 0.2 | 0.29-0.53 | 0.50 |
| (Lge Crimp) | (8.14) | (0.09-0.16) | (0.15) |
| Grid 1 + Struct. Packing A | 0.2-0.3 | 0.40-0.52 | 0.50 |
| (Sm. Crimp) | (8.14-12.22) | (0.12-0.15) | (0.15) |
| Struct. Packing B (Lge.) + | 0.2 | 0.37-0.56 | >0.55 |
| Struct. Packing A (Sm), | (8.14) | (0.11-0.17) | (>0.17) |
| shallow bed | | | |
| Struct. Packing B (Lge.) + | 0.2 | 0.37-0.57 | >0.57 |
| Struct. Packing A (Sm), | (8.14) | (0.11-17) | (>0.17) |
| deep bed | | | |

The following observations were made on the basis of the reported results:
The random packing performed well at low vapor rates but entrainment increased sharply as vapor rates exceeded a critical limit at about 0.37 Cs.
The grid packing was less effective than the random at low vapor rates and at higher rates exhibited a similar sharp increase in entrainment.
The large crimp structured packing on its own was less effective at preventing entrainment than other packings at low vapor rates but the increase in entrainment showed a delayed onset with respect to the random and grid packings.
The combination of the grid packing with the structured packing performed well at low vapor rates but entrainment increased sharply at high rates although with a delayed onset compared to the random and grid packings.
The combined structured packing with the larger crimp packing below the smaller crimp packing gives greatly reduced entrainment at high vapor rates with the improvement notable at higher vapor rates with the combined deep (31 inch/81 cm) bed.

The reduced entrainment noted at high vapor rates with the combined large/small structured packings with the larger crimp packing below the smaller crimp packing reduces entrainment greatly above Cs=0.45 ft/sec (0.137 m/sec) and with particularly notable advantage at rates corresponding to Cs above 0.49 ft/sec (0.15 m/sec). The increase in entrainment resulting from the combination of the two differently sized packings at Cs above 0.5 ft/sec (0.15 m/sec) did not exceed approximately 2.5% with an 81 cm bed height, based on a baseline entrainment of approximately 2% at Cs below 0.50 ft/sec (0.15 m/sec). With the greater bed height of 147 cm, regarded as closer to the optimum, there was no increase in entrainment at all tested Cs.

For practical, full-scale, operation the Cs values noted in these results would need to be subjected to a debit of approximately 10-15% for reliable tower function but even making this allowance, the results imply that the combination of large and small structured packings could be used with confidence of proper operation at high vapor rates corresponding to Cs of 0.40 ft/sec (0.12 m/sec) and higher, notably exceeding Cs of 0.44 ft/sec (0.13 m/sec), for example, at 0.49 ft/sec (0.15 m/sec) and even higher, for example, at Cs of 0.54 ft/sec (0.16 m/sec) or even higher while still maintaining entrainment at acceptably low values.

Compared to a common type of vacuum tower packing (Grid Packing 1), the improvement at vapor rates above 0.45 ft/sec (0.137 m/sec) is notable, indicating the possibility of achieving significantly greater vapor rates in vacuum tower operation without the attendant increase in carry over of heavy ends into the gas oil fractions. The throughput of typical vacuum towers is limited by the capacity of their wash zone. The combination of the two structured packings in the wash zone of the vacuum tower can provides a 20% increase in capacity over grid packings and a 27% increase in capacity over the random packing. The large capacity increase from this, and similar packing combinations, offer significant cost savings opportunities during revamps and more efficient refinery operation.

Apart from the use of the combination of structured packings in the wash zone of the vacuum tower with its potential for high vapor rates of at least 0.45 ft/sec (0.14 m/sec) Cs, the conditions will be conventional and based upon the equipment and the feed being handled. Thus, pressure in the flash zone will be in the typical operating range produced by steam ejectors, typically below 100 mm Hg and as the cut deepens, pressures below 50 mm and even below 20 mm will prevail, even below 10 mm Hg. Flash zone temperatures will be set largely by the feed quality but typically will be in the range of 370 to 425° C. (about 700 to 800° F.) and in most cases 380 to 425° C. (about 720 to 800° F.). Wash liquids fed to the wash zones may be taken from the upper portion of the tower in the conventional manner.

1. A distillation tower comprising:
a feed inlet zone,
a wash zone above the feed inlet zone, the wash zone comprising (i) a lower packing zone of structured packing and (ii) an upper packing zone of structured packing superimposed over the lower packing zone, the lower structured packing having a larger crimp size than the upper structured packing.

2. A distillation tower according to claim 1 in which the structured packing of the lower packing zone has a crimp size of at least 30 mm and the structured packing of the upper packing zone has a crimp size of 5 to 30 mm.

3. A distillation tower according to claim 2 in which the structured packing of the lower packing zone has a crimp size of 30 to 50 mm and the structured packing of the upper packing zone has a crimp size of 10 to 30 mm.

4. A distillation tower according to claim 1 in which the total bed height of the two structured packings is from 1 to 1.5 m.

5. A distillation tower according to claim 1 in which the ratio of the bed heights of the structured packing of the lower packing zone and the structured packing of the upper packing zone is from 30:70 to 70:30.

6. A petroleum refinery vacuum tower comprising:
a feed inlet zone,
a wash zone above the feed inlet zone, the wash zone comprising (i) a lower packing zone of structured packing and (ii) an upper packing zone of structured packing superimposed over the lower packing zone, the lower structured packing having a larger crimp size than the upper structured packing.

7. A vacuum tower according to claim 6 in which the structured packing of the lower packing zone has a crimp size of at least 30 mm and the structured packing of the upper packing zone has a crimp size of 5 to 30 mm.

8. A vacuum tower according to claim 7 in which the structured packing of the lower packing zone has a crimp size of 30 to 50 mm and the structured packing of the upper packing zone has a crimp size of 10 to 30 mm.

9. A vacuum tower according to claim 6 in which the total bed height of the two structured packings is from 1 to 1.5 m.

10. A vacuum tower according to claim 6 in which the ratio of the bed heights of the structured packing of the lower packing zone and the structured packing of the upper packing zone is from 30:70 to 70:30.

11. A method of separating two fluid components from a feed stream by distilling the feed stream in a distillation tower comprising a feed inlet zone and a wash zone above the feed inlet zone through which wash liquid is passed downwards to remove entrained liquid, the wash zone comprising (i) a lower packing zone of structured packing and (ii) an upper packing zone of structured packing superimposed over the lower packing zone, the lower structured packing having a larger crimp size than the upper structured packing, the Cs Factor in the wash zone being at least 0.4 ft/sec.

12. A method according to claim 11 in which the C Factor is at lest 0.45 ft/sec.

13. A method according to claim 11 in which the structured packing of the lower packing zone has a crimp size of at least 20 mm and the structured packing of the upper packing zone has a crimp size of 8 to 20 mm.

14. A method according to claim 12 in which the structured packing of the lower packing zone has a crimp size of 20 to 35 mm and the structured packing of the upper packing zone has a crimp size of 8 to 15 mm.

15. A method according to claim 1 in which the total bed height of the two structured packings is from 1 to 1.5 m and the ratio of the bed heights of the structured packing of the lower packing zone and the structured packing of the upper packing zone is from 40:60 to 60:40.

16. A method of separating two hydrocarbon components of different boiling range from a residual feed stream from the atmospheric distillation of a petroleum crude oil, which comprises distilling the residual feed stream in a vacuum tower comprising a feed inlet zone, a lower stripping zone below the feed inlet zone and an upper wash zone above the feed inlet zone, the wash zone comprising (i) a lower packing zone of structured packing and (ii) an upper packing zone of structured packing superimposed over the lower packing zone, the lower structured packing having a larger crimp size than the upper structured packing, the distillation being carried out under reduced pressure at a Cs in the wash zone of at least 0.40 ft/sec.

17. A method according to claim 16 in which the Cs is at least 0.45 ft/sec.

18. A method according to claim 16 in which the structured packing of the lower packing zone has a crimp size of at least 30 mm and the structured packing of the upper packing zone has a crimp size of 5 to 30 mm.

19. A method according to claim 18 in which the structured packing of the lower packing zone has a crimp size of 30 to 50 mm and the structured packing of the upper packing zone has a crimp size of 10 to 25 mm.

20. A method according to claim 16 in which the total bed height of the two structured packings is from 1 to 1.5 m and the ratio of the bed heights of the structured packing of the lower packing zone and the structured packing of the upper packing zone is from 30:70 to 70:30.
